(19) United States
(12) Patent Application Publication
(10) Pub. No.: US 2012/0082225 A1
(43) Pub. Date: Apr. 5, 2012

(54) SELECTIVE INDICATION OF TRANSFORM SIZES

(75) Inventors: Peisong Chen, SAN DIEGO, CA (US); Marta Karczewicz, SAN DIEGO, CA (US); Rahul P. Panchal, SAN DIEGO, CA (US)

(73) Assignee: QUALCOMM INCORPORATED, San Diego, CA (US)

(21) Appl. No.: 13/249,015

(22) Filed: Sep. 29, 2011

Related U.S. Application Data
(60) Provisional application No. 61/389,095, filed on Oct. 1, 2010.
(60) Provisional application No. 61/451,343, filed on Mar. 10, 2011.

(51) Int. Cl. H04N 7/50

(52) U.S. Cl. 375/240.12; 375/E07.211

(57) ABSTRACT

During a video encoding process, a video encoder may transform the residual data of a coding unit (CU) using a single transform if the CU only has a single prediction unit (PU). If the CU has multiple PUs, the video encoder may transform the residual data using multiple transforms. The video encoder outputs an indication of the size of a transform used to transform residual data of the CU only when the CU has more than one PU. If a video decoder receives such an indication, the video decoder may reconstruct residual data of the CU using a transform of the indicated size. Otherwise, the video decoder may reconstruct the residual data of the CU using a transform having same size as the CU.

### CROSS-REFERENCE TO RELATED APPLICATIONS

This application claims the benefit of U.S. Provisional Application No. 61/389,095, filed Oct. 1, 2010, and U.S. Provisional Application No. 61/451,343, filed Mar. 10, 2011, the entire content of each being hereby incorporated by reference.

### BACKGROUND

Digital video capabilities may be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into blocks. Each block may be further partitioned. Blocks in an intra-coded (I) frame or slice are encoded using spatial prediction with respect to neighboring blocks. Blocks in an inter-coded (P or B) frame or slice may use spatial prediction with respect to neighboring blocks in the same frame or slice or temporal prediction with respect to other reference frames.

### SUMMARY

Generally, the techniques described in this disclosure may increase the coding efficiency for a coding unit (CU) by limiting signaling of sizes of transforms used to transform residual data of the CU. As described in this disclosure, an encoding unit implements the techniques of this disclosure to generate residual data for the CU. If the CU has a single prediction unit (PU), the encoding unit may use a single transform to transform the residual data. If the CU has multiple PU's, the encoding unit may use multiple transforms to transform the residual data. The encoding unit only outputs an indication of the size of the transform when the CU has more than one PU. In other words, the encoding unit may not output an indication of a size of the transform when the CU only has one PU. If a decoding unit does not receive an indication of the size of the transform, the decoding unit may assume that the transform has the same size as the residual data of the CU. By not including an indication of the size of the transform, coding efficiency of the CU may be enhanced.

In one example, this disclosure describes a method of encoding video data. The method comprises generating residual data for a CU of the video data. The method also comprises transforming the residual data using at least one transform, the transform having a particular transform size. In addition, the method comprises determining whether the CU has more than one prediction unit. The method also comprises outputting an indication of the transform size only after determining that the CU has more than one prediction unit.

In another example, this disclosure describes a method for decoding video data. The method comprises receiving syntax elements. The syntax elements include a transform size syntax element for a CU of video data only when the CU has more than one prediction unit. The transform size syntax element indicates the transform size. The method also comprises determining whether the syntax elements include the transform size syntax element. In addition, the method comprises transforming a transform coefficient block for the CU into residual data for the CU using a first transform after determining that the syntax elements do not include the transform size syntax element. The first transform has a same size as the residual data for the CU. In addition, the method comprises reconstructing the sample block of the CU based on the residual data for the CU.

In another example, this disclosure describes a computing device that comprises a processor configured to generate residual data for a CU of video data. The processor is further configured to transform the residual data using at least one transform, the transform having a particular transform size. In addition, the processor is configured to determine whether the CU has more than one prediction unit. The processor is also configured to output an indication of the transform size only after determining that the CU has more than one prediction unit.

In another example, this disclosure describes a computing device that comprises a processor configured to receive syntax elements. The syntax elements include a transform size syntax element for a CU of video data only when the CU has more than one prediction unit. The transform size syntax element indicates a transform size. In addition, the processor is configured to determine whether the syntax elements include the transform size syntax element. The processor is also configured to transform a transform coefficient block for the CU into residual data for the CU using a first transform after determining that the syntax elements do not include the transform size syntax element. The first transform has a same size as the residual data for the CU. Furthermore, the processor is configured to reconstruct the sample block of the CU based on the residual data for the CU.

In another example, this disclosure describes a computing device comprising means for generating residual data for a CU of video data. The computing device also comprises means for transforming the residual data using at least one transform, the transform having a particular transform size. In addition, the computing device comprises means for determining whether the CU has more than one prediction unit. The computing device also comprises means for outputting an indication of the transform size only after determining that the CU has more than one prediction unit.

In another example, this disclosure describes a computing device comprising means for receiving syntax elements. The syntax elements include a transform size syntax element for a CU of video data only when the CU has more than one prediction unit. The transform size syntax element indicates a transform size. In addition, the computing device comprises means for determining whether the syntax elements include the transform size syntax element. Furthermore, the computing device comprises means for transforming a transform coefficient block for the CU into residual data for the CU using a first transform after determining that the syntax elements do not include the transform size syntax element, the first transform having a same size as the CU. The computing device also comprises means for reconstructing the sample block of the CU based on the residual data for the CU.

In another example, this disclosure describes a computer program product that comprises a computer-readable storage medium that stores program instructions that cause a computing device to generate residual data for a CU of video data. The program instructions also cause the computing device to transform the residual data using at least one transform, the transform having a particular transform size. In addition, the program instructions cause the computing device to determine whether the CU has more than one prediction unit. Furthermore, the program instructions cause the computing device to output an indication of the transform size only after determining that the CU has more than one prediction unit.

In another example, this disclosure describes a computer program product that comprises a computer-readable storage medium that stores program instructions that cause a computing device to determine whether syntax elements for a CU of video data include a transform size syntax element. The syntax elements include the transform size syntax element only when the CU has more than one prediction unit. The transform size syntax element indicates a transform size. The program instructions also cause the computing device to transform a transform coefficient block for the CU into residual data using a transform after determining that the syntax elements do not include the transform size syntax element, the transform having a same size as the residual data of the CU. In addition, the program instructions cause the computing device to reconstruct a sample block of the CU based on the residual data for the CU.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram that illustrates an example multimedia encoding and decoding system.

FIG. 2 is a conceptual diagram that illustrates an example series of frames in a video.

FIG. 3 is a block diagram that illustrates an example configuration of an encoding unit.

FIG. 4 is a conceptual diagram that illustrates an example frame partitioned into treeblocks.

FIG. 5 is a conceptual diagram that illustrates a further example partitioning of treeblocks.

FIG. 6 is a block diagram that illustrates an example configuration of an inter-prediction unit.

FIG. 7 is a block diagram that illustrates an example configuration of a decoding unit.

FIG. 8 is a flowchart that illustrates an example inter-frame coding operation performed by an inter-prediction unit on a CU.

FIG. 9 is a conceptual diagram that illustrates example rectangular partitioning modes.

FIG. 10 is a conceptual diagram that illustrates example geometric partitioning modes.

FIG. 11 is a conceptual diagram that illustrates an example quadtree data structure.

FIG. 12 is a flowchart illustrating an example operation to generate a node of the quadtree.

FIG. 13 is a flowchart illustrating an example operation performed by the decoding unit.

### DETAILED DESCRIPTION

The attached drawings illustrate examples. Elements indicated by reference numbers in the attached drawings correspond to elements indicated by like reference numbers in the following description. In the attached drawings, ellipses indicate the presence of one or more elements similar to those separated by the ellipses. Furthermore, stacked elements in the attached drawings indicate the presence of one or more similar elements. Alphabetical suffixes on reference numbers for similar elements are not intended to indicate the presence of particular numbers of the elements. In this disclosure, elements having names that start with ordinal words (e.g., “first,” “second,” “third,” and so) do not necessarily imply that the elements have a particular order. Rather, such ordinal words may merely be used to refer to different elements of the same or similar kind.

A frame of video data is associated with one or more blocks of samples. In this disclosure, the term “sample” may refer to a value defining a component of a pixel, such as a luma or a chroma component of the pixel. Furthermore, in this disclosure, a two-dimensional array of such samples may be referred to as a “sample block.” Each sample block of the frame can specify different components of the pixels in the frame.

An encoder may first partition a frame into “slices.” A slice is a term used generally to refer to independently decodable portions of the frame. The encoder may next partition these slices into “treeblocks.” A treeblock may also be referred to as a largest coding unit (LCU). The encoder may partition the treeblocks into a hierarchy of progressively smaller sample blocks, which when illustrated may be represented as a hierarchical tree structure, hence the name “treeblocks.” Partitioning treeblocks in this way may enable the encoder to capture motion of different sizes. Each undivided sample block corresponds to a different coding unit (CU). For ease of explanation, this disclosure may refer to the sample block corresponding to a CU as the sample block of the CU.

The encoder can generate one or more prediction units (PU's) for each of the CU's. The encoder can generate the PU's for a CU by partitioning the sample block of the CU into prediction areas. The encoder may then perform a motion estimation operation with respect to each PU of the CU. When the encoder performs the motion estimation operation with respect to a given PU, the encoder generates motion information for the PU. The encoder uses the motion information determined for the PU's to generate a prediction block for the CU. The encoder compares the prediction block for a CU with the original sample block of the CU to determine residual data for the CU.

The encoder may generate one or more transform units (TU's) for each of the CU's. The TU's define transform information for transforming the residual data from a spatial domain to a frequency domain. The encoder can generate this transform information for the TU's by partitioning the residual data into transform areas. The encoder may then perform transform operations for each of the transform areas. When the encoder performs a transform operation for one of the TU's, the encoder applies a transform to transform the residual data identified by the transform area into a transform coefficient block.

Techniques of this disclosure may increase the coding efficiency for a CU by potentially limiting signaling of sizes of transforms used when encoding data of the CU. As described in this disclosure, an encoder generates residual data based on a sample block of the CU and a prediction block of the CU. If the encoder only determines that a single transform operation is required to transform the residual data associated with any given CU, the encoder does not output a syntax element that indicates a size of the transform, as the transform size may be implied in this context to be the size identified for the sample block considering that all of the residual data is transformed from the spatial to the frequency domain. By not including this syntax element when only a single transform operation is used, coding efficiency of the CU may be enhanced.

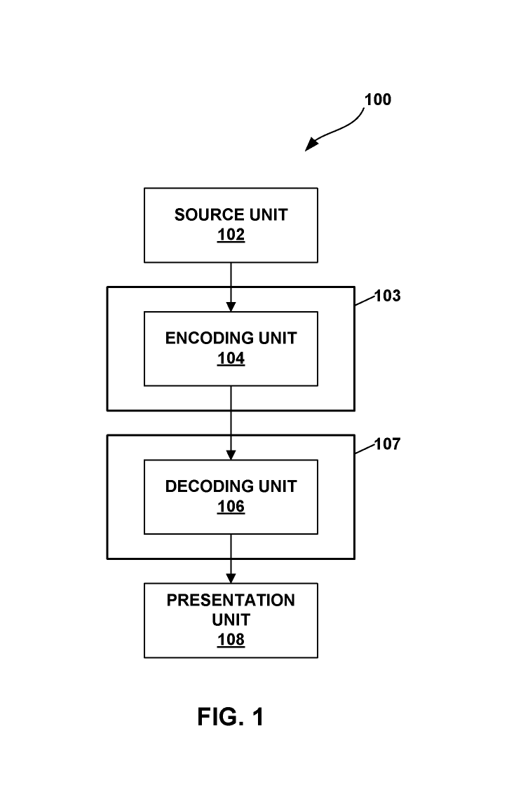

FIG. 1 is a block diagram that illustrates an example multimedia encoding and decoding system 100. Multimedia encoding and decoding system 100 captures video data, encodes the captured video data, transmits the encoded video data, decodes the encoded video data, and then plays back the decoded video data.

Multimedia encoding and decoding system 100 comprises a source unit 102, an encoding unit 104, a decoding unit 106, and a presentation unit 108. Source unit 102 generates video data. Encoding unit 104 encodes the video data. Decoding unit 106 decodes the encoded video data. Presentation unit 108 presents the decoded video data.

One or more computing devices implement source unit 102, encoding unit 104, decoding unit 106, and presentation unit 108. In this disclosure, the term computing device encompasses physical devices that process information. Example types of computing devices include personal computers, laptop computers, mobile telephones, smartphones, tablet computers, in-car computers, television set-top boxes, video conferencing systems, video production equipment, video cameras, video game consoles, or others types of devices that process information.

In some examples, a single computing device may implement two or more of source unit 102, encoding unit 104, decoding unit 106, and presentation unit 108. For example, a single computing device may implement source unit 102 and encoding unit 104. In this example, another computing device may implement decoding unit 106 and presentation unit 108. In other examples, different computing devices implement source unit 102, encoding unit 104, decoding unit 106, and presentation unit 108.

In the example of FIG. 1, a computing device 103 implements encoding unit 104 and a computing device 107 implements decoding unit 106. In some examples, computing device 103 may provide functionality in addition to encoding unit 104. Furthermore, in some examples, computing device 107 may provide functionality in addition to decoding unit 106.

As mentioned briefly above, source unit 102 generates video data that represent a series of frames. A frame is also commonly referred to as a “picture.” When the series of frames in the video data are presented to a user in rapid succession (e.g., 24 or 25 frames per second), the user may perceive objects in the frames to be in motion.

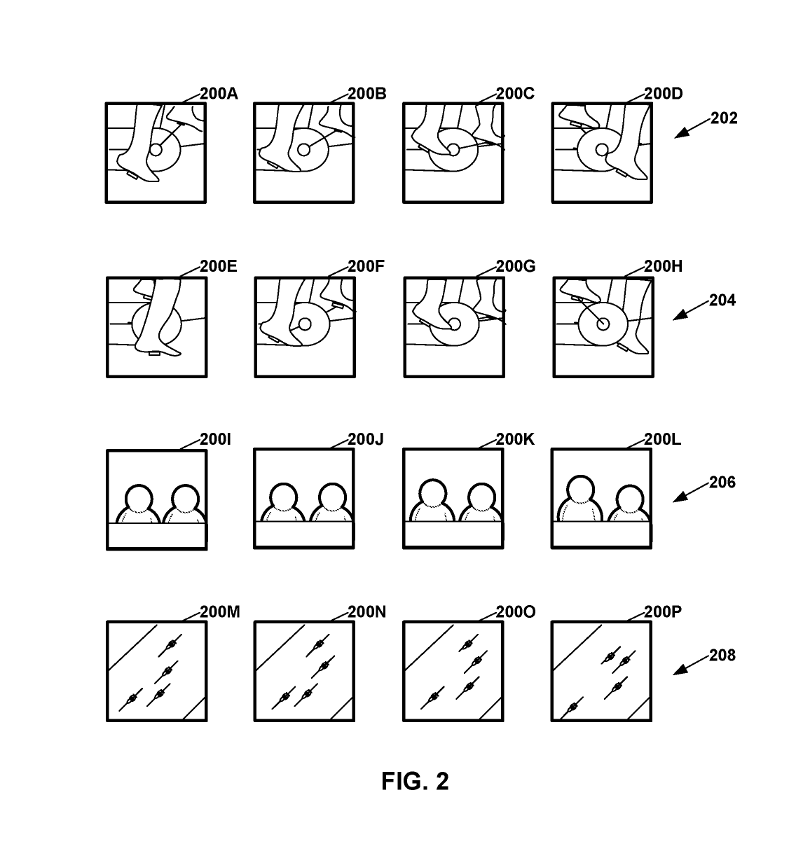

FIG. 2 is a conceptual diagram that illustrates an example series of frames 200A through 200P in video data. This disclosure refers collectively to frames 200A through 200P as “frames 200.” The video data represents scenes of a bicycle race. The frames in rows 202 and 204 show a scene of a person pedaling a bicycle. The frames in row 206 show two commentators sitting behind a desk. The frames in row 208 show a scene of bicycle racers from overhead. Each frame within a scene may differ slightly from the preceding frame. By presenting frames 200 in rapid succession, users may perceive the motion in these scenes.

Continuing reference is now made to the example of FIG. 1. In various examples, source unit 102 generates the video data in various ways. For example, source unit 102 may comprise a video camera. In this example, the video camera captures images from a visible environment. In another example, source unit 102 may comprise one or more sensors for medical, industrial, or scientific imaging. Such sensors may include x-ray detectors, magnetic resonance imaging sensors, particle detectors, and so on. In yet another example, source unit 102 may comprise an animation system. In this example, one or more users use the animation system to draw, draft, program, or otherwise design the content of the video data from their imaginations.

Encoding unit 104 receives the video data generated by source unit 102. Encoding unit 104 encodes the video data such that less data represents the series of frames in the video data. In some instances, encoding the video data in this way may be necessary to ensure that the video data may be stored on a given type of computer-readable media, such as a DVD or CD-ROM. Furthermore, in some instances, encoding the video data in this way may be necessary to ensure that the video data may be efficiently transmitted over a communication network, such as the Internet. As described in greater detail elsewhere in this disclosure, encoding unit 104 may not output a syntax element that indicates a size of a transform when encoding unit 104 only uses a single transform to transform the residual data of a CU of a frame in the video data.

Encoding unit 104 may encode video data, which is often expressed as a sequence or series of video frames. Encoding unit 104 may split these frames into independently decodable portions (which are commonly referred to as “slices”), which in turn, encoding unit 104 may split into treeblocks. These treeblocks may undergo a form of recursive hierarchical quadtree splitting. Encoding unit 104 may perform this splitting operation to generate a hierarchical tree-like data structure, with the root node being a “treeblock.” Each undivided sample block within a treeblock corresponds to a different CU. The CU of an undivided sample block may contain information, including motion information and transform information, regarding the undivided sample block.

Encoding unit 104 may generate one or more PU's for each CU. When encoding unit 104 generates the PUs of a CU, encoding unit 104 partitions the sample block of the CU into one or more prediction areas. Each of the prediction areas corresponds to a different PU of the CU. As described in detail elsewhere in this disclosure, encoding unit 104 may use rectangular and/or geometric partitioning modes to generate the PU's of a CU. Encoding unit 104 then perform motion estimation operations with respect to each of the PU's. When encoding unit 104 performs the motion estimation operation with respect to a PU, encoding unit 104 generates motion information for the PU. The motion information for a PU may identify a reference sample in a reference frame. The reference frame may either be the current frame (for intra-coding) or a different frame (for inter-coding). After performing the motion estimation operations with respect to each PU of a CU, encoding unit 104 may use the motion information for the PU's to perform a motion compensation operation that generates a prediction block for the CU.

Encoding unit 104 determines residual data for the CU by comparing the original sample block of the CU to the prediction block of the CU. After determining this residual data, encoding unit 104 may transform the residual data. To transform the residual data, encoding unit 104 may partition the residual data into one or more transform areas. Encoding unit 104 then applies a transform operation to each of the transform areas. When encoding unit 104 applies the transform operation to a transform area, encoding unit 104 transform samples of the residual data that are within the transform area into a block of transform coefficients. This disclosure may refer to a block of transform coefficients as a transform coefficient block. Each of the transform areas corresponds to a different TU of the CU. The transform area corresponding to a TU may be referred to herein as the transform area of the TU. A TU may store the coefficient block generated by transforming the samples of the residual data that are within the transform area of the TU.

Encoding unit 104 may quantize the transform coefficient blocks of a CU. Encoding unit 104 may then finish encoding the data of the CU by performing entropy encoding operations on the quantized transform coefficient blocks of the CU along with other data of the CU. By encoding the data of CU's of frames in the video data in this manner, encoding unit 104 may generate an encoded version of the video data.

Decoding unit 106 receives the encoded video data. In various examples, decoding unit 106 may receive the encoded video data in various ways. For example, decoding unit 106 may receive a computer-readable medium, such as a DVD, that stores the video data. In another example, decoding unit 106 may receive the encoded video data from a communication medium, such as the Internet, a local area network (LAN), a cable connected to another computing device, or a wireless networking link.

After receiving the encoded video data, decoding unit 106 decodes the encoded video data. When decoding unit 106 decodes the encoded video data, decoding unit 106 converts the encoded video data into a format that presentation unit 108 may use to present the video data to a user. Typically, more data is used to represent the decoded video data than is used to represent the encoded video data.

Presentation unit 108 receives the decoded video data from decoding unit 106. In various examples, presentation unit 108 receives the decoded video data in various ways. For example, where a single computing device provides decoding unit 106 and the presentation system 108, presentation unit 108 may receive the decoded video data via one or more internal communication media, such as cables or buses. In another example, presentation unit 108 may receive the decoded video data from one or more computer-readable media, such as a network connection, DVD, CD-ROM, solid-state memory device, and so on. After receiving the decoded video data, presentation unit 108 presents the frames in the decoded video data to one or more users.

In accordance with the techniques described in this disclosure, encoding unit 104 may more efficiently (in term of bits) encode video data by refraining from specifying or limiting syntax elements used to express syntax that may be required to decode encoded video data identified by a CU. In implementing these techniques, encoding unit 104 may generate residual data for a CU of the video data in the manner described above. That is, encoding unit 104 may generate residual data through comparison of the sample block and the prediction block. Encoding unit 104 typically determines residual data by subtracting the sample block of the CU from the prediction block of the same CU.

Next, encoding unit 104 determines transform areas for the generated residual area and applies one or more transforms to the determined transform areas so as to transform the residual data using at least one transform. Each transform is typically applied to either rectangular or square areas of a particular size, meaning that the at least one transform has a corresponding size. Encoding unit 104 may then output an indication of the transform size only when the CU has more than one PU rather than always output an indication of the transform size regardless of whether the CU has more than one PU. Because encoding unit 104 refrains from outputting this indication of transform size when the CU only has one PU, decoding unit 106 may infer that the transform size is the same as the size of the residual data of the CU when the CU only has a single PU. Rather than redundantly output the indication of the transform size, encoding unit 104 implements the techniques described in this disclosure to, in some instances, reduce redundant indication of the transform size. By enabling encoding unit 104 to eliminate this indication in instances when such indication is redundant, the techniques may improve coding efficiency (in terms of bits) without sacrificing video quality or preventing successful decoding of such video data.

Decoding unit 106 may receive video data encoded in accordance with the techniques of this disclosure and implement corresponding decoding techniques in the manner described in more detail below. For instance, decoding unit 106 may determine whether syntax elements for a CU include a transform size syntax element. If the syntax elements do not include a transform size syntax element, decoding unit 106 may infer that encoding unit 104 used a transform having the same size as the residual data of the CU to generate a transform coefficient block of the CU. Hence, decoding unit 106 may transform the transform coefficient block of the CU into residual data for the CU using a transform having a same size as the residual data for the CU.

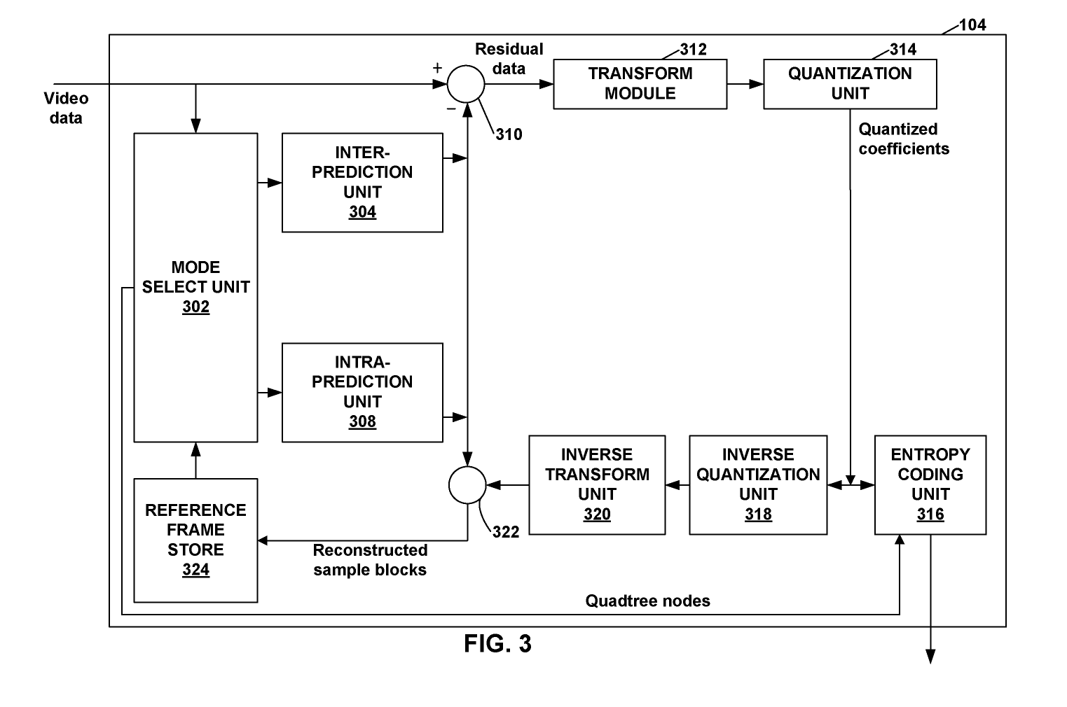

FIG. 3 is a block diagram that illustrates an example configuration of encoding unit 104. In the example of FIG. 3, encoding unit 104 provides a mode select unit 302, an inter-prediction unit 304, an intra-prediction unit 308, a residual generation unit 310, a transform module 312, a quantization unit 314, an entropy coding unit 316, an inverse quantization unit 318, an inverse transform unit 320, a reconstruction unit 322, and a reference frame store 324. Readers will understand that some examples of encoding unit 104 may comprise more, fewer, or different units.

In various examples, encoding unit 104 implements mode select unit 302, inter-prediction unit 304, intra-prediction unit 308, residual generation unit 310, transform module 312, quantization unit 314, entropy coding unit 316, inverse quantization unit 318, inverse transform unit 320, reconstruction unit 322, and reference frame store 324 in various ways. For example, the one or more computing devices that implement encoding unit 104 may implement one or more of these units when processors of the one or more computing devices execute certain computer-readable instructions stored on one or more computer-readable media. In this example, these units or modules may or may not be implemented as discrete, modular pieces of computer software. In another example, the one or more computing devices that implement encoding unit 104 may comprise one or more application-specific integrated circuits (ASICs) that implement the functionality of one or more of these units. In some examples, the functionality of these units may be provided by separate computing devices.

Encoding unit 104 receives data representing frames of video data. When encoding unit 104 receives data representing a frame, encoding unit 104 encodes the frame. For ease of explanation, this disclosure refers to the frame being encoded as the source frame. The data representing the frame comprises one or more blocks of samples.

To encode the source frame, mode select unit 302 partitions a sample block of the frame among a plurality of treeblocks. In some instances, a treeblock may be an N×N block of luma samples and two corresponding blocks of chroma samples. In some examples, a block is two-dimensional array of samples or transform coefficients. In other instances, a treeblock may be block of luma samples or a chroma sample array.

Mode select unit 302 generates a quadtree for each of the treeblocks. The quadtree for a treeblock comprises a hierarchy of nodes. Initially, the quadtree of the given treeblock only comprises a root node. The root node corresponds to the given treeblock. Mode select unit 302 may partition the given treeblock into multiple smaller sample blocks (i.e., sub-blocks). When mode select unit 302 partitions the given treeblock into sub-blocks, mode select unit 302 adds child nodes to the quadtree of the given treeblock. Each of the child nodes corresponds to a different one of the sub-blocks. In some examples, mode select unit 302 may partition one or more of the sub-blocks into yet smaller sample blocks (i.e., sub-sub-blocks). When mode select unit 302 partitions a sub-block into sub-sub-blocks, mode select unit 302 may add grandchild nodes to the quadtree of the given treeblock. Each of the grandchild nodes corresponds to one of the sub-sub-blocks. The grandchild nodes are children of the child nodes. Mode select unit 302 may continue partitioning the sample block of the given treeblock and generating nodes in the quadtree of the given treeblock as appropriate, up to a pre-configured limit. Unpartitioned sample blocks within the given treeblock correspond to leaf nodes of the quadtree. The leaf nodes of the quadtree may be referred herein as coding nodes.

Each of the coding nodes corresponds to a different CU. A coding node of a CU is a root node of a prediction tree and a transform tree. The prediction tree stores information of PU's of the CU. For example, the prediction tree may specify sizes and positions of prediction areas of the PU's. The PU's of the CU may also comprise additional associated prediction data. The transform tree stores information regarding TU's of the CU. For example, the transform tree may store specify sizes and positions of transform area of the TU's. The TU's of the CU may also comprise additional associated transform data. For ease of explanation, this disclosure may refer to the size of the transform area of a TU as the size of the TU.

In some examples, mode select unit 302 may generate the multiple different quadtrees for each of the treeblocks of the source frame. In such examples, encoding unit 104 may determine which of the quadtrees for a treeblock encodes a sample block of the treeblock with a least amount of distortion. The amount of distortion in a sample block may be correlated with amount of difference between the sample block and an original version of the sample block.

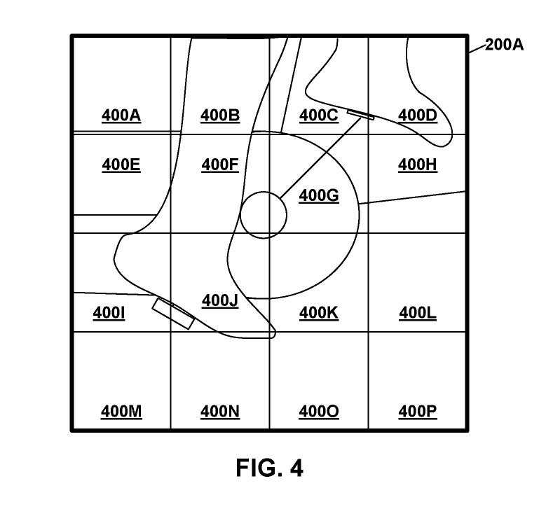

FIG. 4 is a conceptual diagram that illustrates example frame 200A partitioned into treeblocks 400A through 400P (collectively, “treeblocks 400”). Each of treeblocks 400 is square and has the same size. For example, the sample blocks of treeblocks 400 may be 32 samples wide by 32 samples high (i.e., 32×32). In another example, the sample blocks of treeblocks 400 may be 64 samples wide by 64 samples high (i.e., 64×64).

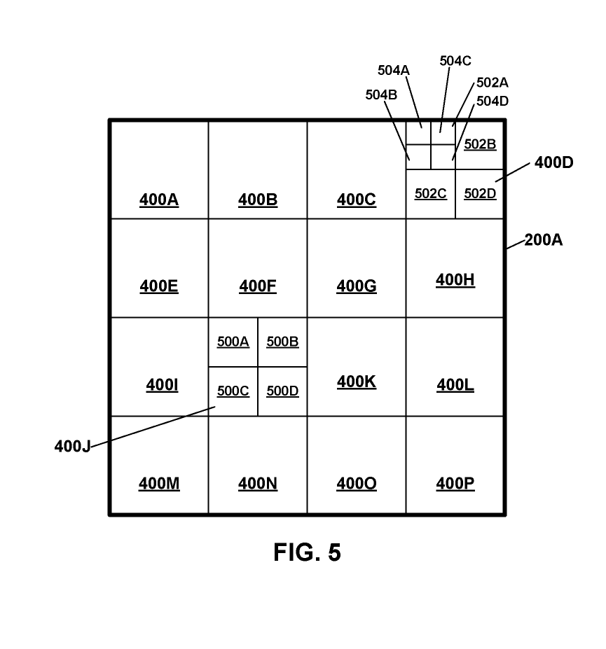

FIG. 5 is a conceptual diagram that illustrates a further example partitioning of treeblocks 400. In the example of FIG. 5, mode select unit 302 has partitioned the sample block of treeblock 400J into four smaller sample blocks 500A through 500D. Furthermore, in the example of FIG. 5, mode select unit 302 has partitioned sample block 400D into four sample blocks 502A through 504D. Mode select unit 302 has further subdivided sample block 502A into four more sample blocks 504A through 504D.

Continuing reference is now made to the example of FIG. 3. After mode select unit 302 generates a quadtree for a treeblock, inter-prediction unit 304 performs an inter-frame coding operation that generates prediction blocks for CU' s of the treeblock. The prediction block of a CU is a block of predicted samples. The prediction block for a CU may differ somewhat from the sample block of the CU. For example, samples in the prediction block of the CU may have slightly different colors or brightness from the corresponding samples of the sample block of the CU.

Intra-prediction unit 308 may use samples in the sample blocks of other CU's of the source frame to generate a prediction block for the CU. In various examples, intra-prediction unit 308 generates the prediction block in various ways. For example, intra-prediction unit 308 may generate the prediction block of the CU such that samples in neighboring CU's extend horizontally across or vertically down through the prediction block. Intra-prediction unit 308 may also select an intra-prediction mode that best corresponds to the sample block of the CU.

After inter-prediction unit 306 and intra-prediction unit 308 generate prediction blocks for the CU, mode select unit 302 may select one of the prediction blocks for the CU. If the mode select unit 302 selects a prediction block generated by intra-prediction unit 308, mode select unit 302 may add a syntax element to the coding node of the CU to indicate the intra-prediction mode that intra-prediction unit 308 used when generating the selected prediction block. If mode select unit 302 selects a prediction block generated by inter-prediction unit 304, mode select unit 302 may add a syntax element to the coding node for the CU that indicates that inter-prediction was used to encode the CU.

In addition, mode select unit 302 may add syntax elements to the prediction tree of the CU. For example, mode select unit 302 may add syntax elements to the prediction tree indicating the sizes and locations of PU's of the CU, motion vectors for the PU's, and other data generated during the inter-frame coding operation.

Furthermore, mode select unit 302 may add syntax elements to the transform tree of the CU. For example, mode select unit 302 may add syntax elements to the transform tree indicating the sizes and locations of transform areas of TU's of the CU. In accordance with the techniques of this disclosure, mode select unit 302 may determine whether the CU has more than one PU. Mode select unit 302 may add to the transform tree an indication of a transform size of transform area of a TU in response to determining that the CU has more than one PU. On the other hand, mode select unit 302 may not add to the transform tree an indication of the transform size of transform area of a TU if mode select unit 302 determines that the CU only has one PU.

After mode select unit 302 selects a prediction block of the CU, residual generation unit 310 may use the sample block of the CU and the selected prediction block of the CU to generate residual data for the CU. In some examples, the residual data for the CU may be arranged as a two-dimensional array of the residual data (i.e., a residual block). The residual data for the CU may represent the differences between the sample block of the CU and the prediction block of the CU. In various examples, residual generation unit 310 may generate the residual data in various ways. For example, residual generation unit 310 may generate the residual data for the CU by subtracting the samples in the prediction block of the CU from the samples in the sample block of the CU.

As mentioned briefly above, each CU has one or more TU's. A transform unit may comprise a transform tree and associated transform data. The transform tree may include transform nodes. Each of the transform nodes specifies the size and position of a transform area of a different TU. For example, the transform tree may include a transform node that indicates the location of an upper left corner of a transform area. In this example, the size of the transform area may be derived from a depth of the transform node a within the transform tree.

When residual generation unit 310 generates residual data for the CU, transform module 312 may perform a transform operation for each TU of the CU. When transform module 312 performs the transform operation for a TU of the CU, transform module 312 applies a two-dimensional transform to applicable samples of the residual data, thereby generating a transform coefficient block. In accordance with the techniques of this disclosure, transform module 312 applies exactly one two-dimensional transform to the applicable samples of the residual data. This two-dimensional transform has a size equal to a size of the residual data of the CU. The applicable samples of the residual data are samples of the residual data in the transform area specified by the TU. The transform coefficient block is a two-dimensional array of transform coefficients. In some examples, a transform coefficient may be a scalar quantity, considered to be in a frequency domain, that is associated with a particular one-dimensional or two-dimensional frequency index in an inverse transform part of a decoding process.

In various examples, transform module 312 may apply the two-dimensional transform to the applicable samples of the residual data in various ways. For example, transform module 312 may apply the two-dimensional transform to the applicable samples by applying one two-dimensional transform to the applicable samples. In other examples, transform module 312 may apply the two-dimensional transform to the applicable samples by applying multiple one-dimensional transforms to the applicable samples. For ease of explanation, this disclosure may describe applying a two-dimensional transform as simply applying a transform.

When transform module 312 performs the transform operation on samples of the residual data, transform module 312 applies a mathematical transformation to the transform coefficient block. For example, transform module 312 may perform a Discrete Cosine Transform (DCT) on the transform coefficient block to transform the video data from the spatial domain to the frequency domain.

Transform module 312 may provide the resulting transform coefficient block to quantization unit 314. Quantization unit 314 may perform a quantization operation on the transform coefficient block. When quantization unit 314 performs the quantization operation, quantization unit 314 may quantize each of the transform coefficients in the transform coefficient block, thereby generating a quantized transform coefficient block. The quantized transform coefficient block is a two-dimensional array of quantized transform coefficients. In various examples, quantization unit 314 performs various quantization operations. For example, quantization unit 314 may perform a quantization operation that quantizes the transform coefficients by dividing the transform coefficients by a quantization parameter and then clipping the resulting quotients.

After quantization unit 314 performs the quantization operation on the transform coefficient blocks of the CU, entropy coding unit 316 performs an entropy coding operation on the quantized transform coefficient block of the CU, the coding node of the CU, the prediction tree of the CU, and the transform tree of the CU. Entropy coding unit 314 generates entropy coded data for the CU as a result of performing this entropy coding operation. In some instances, when entropy coding unit 316 performs the entropy coding operation, quantization unit 314 may reduce the number of bits needed to represent the data of the CU. In various instances, entropy coding unit 316 may perform various entropy coding operations on the data of the CU. For example, entropy coding unit 316 may perform a context-adaptive variable-length coding (CAVLC) operation or a context-adaptive binary arithmetic coding (CABAC) operation on the data of the CU.

Encoding unit 104 outputs a bitstream that includes entropy encoded data for the CU. In various examples, encoding unit 104 may output various types of bitstreams that include the entropy encoded data for the CU. For example, encoding unit 104 may output a NAL unit stream. In this example, the NAL unit stream comprises a sequence of syntax structures called NAL units. The NAL units are ordered in decoding order. The one or more of the NAL units may include the entropy encoded data for the CU. In another example, encoding unit 104 may output a byte stream. Encoding unit 104 constructs the byte stream from a NAL unit stream by ordering NAL units in decoding order and prefixing each NAL unit with a start code prefix and zero or more zero-value bytes to form a stream of bytes. The entropy encoded data for the CU includes an indication of a transform size only when the CU has more than only PU. Hence, when encoding unit 104 outputs the bitstream, encoding unit 104 outputs an indication of a transform size only after determining that the CU has more than one PU.

In some examples, a syntax element is a parse-able element of data represented in a bitstream. A bitstream may be a parse-able sequence of bits that forms a representation of coded pictures and associated data forming one or more coded video sequences. A coded video sequence may be a sequence of access units. An access unit may be a set of network abstraction layer (NAL) units that are consecutive in decoding order and contain exactly one primary coded picture. A NAL unit may be a syntax structure containing an indication of the type of data to follow and bytes containing that data in the form of a raw byte sequence payload interspersed as necessary with emulation prevention bits. A primary coded picture may be a coded representation of a picture to be used by a decoding process for a bitstream.

Inverse quantization unit 318 performs an inverse quantization operation on quantized transform coefficient blocks. The inverse quantization operation at least partially reverses the effect of the quantization operation performed by quantization unit 314, thereby generating transform coefficient blocks.

Inverse transform unit 320 performs an inverse transform operation on transform coefficient blocks generated by inverse quantization unit 318. When inverse transform unit 320 performs the inverse transform operation, inverse transform unit 320 reverses the effect of the transformation operation performed by transform module 312, thereby generating reconstructed residual data.

Reconstruction unit 322 performs a reconstruction operation that generates reconstructed sample blocks. Reconstruction unit 322 generates the reconstructed sample blocks based on the reconstructed residual data and the prediction blocks generated by inter-prediction unit 304 or intra-prediction unit 308. In various examples, reconstruction unit 322 performs various reconstruction operations. For example, reconstruction unit 322 may perform the reconstruction operation by adding the samples in the reconstructed residual data with corresponding samples in the prediction blocks.

Reference frame store 324 stores the reconstructed sample blocks. After encoding unit 104 has encoded data for each CU of the source frame, encoding unit 104 has generated reconstructed sample blocks for each CU in the source frame. Hence, reference frame store 324 stores a complete reconstruction of the source frame. Mode select unit 302 may provide the reconstruction of the source frame to inter-prediction unit 304 as a reference frame.

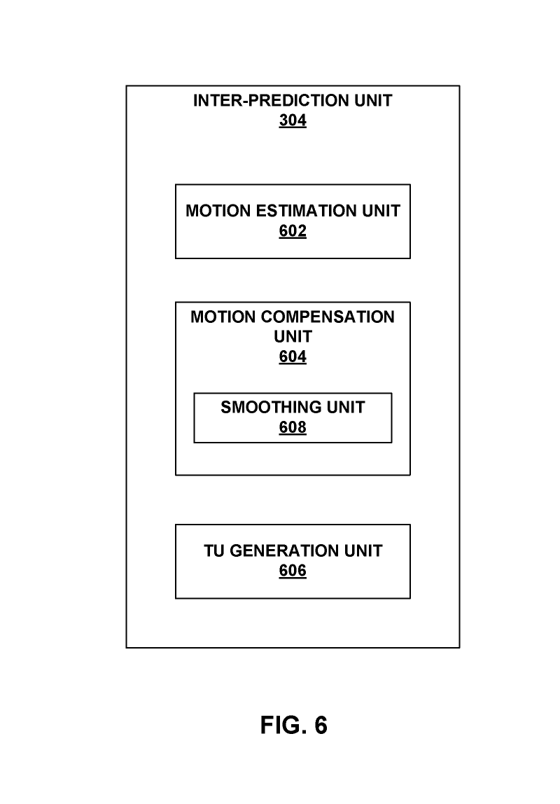

FIG. 6 is a block diagram that illustrates an example configuration of inter-prediction unit 304. In the example of FIG. 6, inter-prediction unit 304 comprises a motion estimation unit 602, a motion compensation unit 604, and a TU generation unit 606. Motion compensation unit 604 comprises a smoothing unit 608. Readers will understand that other example configurations of inter-prediction unit 304 may include more, fewer, or different components.

As described in detail elsewhere in this disclosure, motion estimation unit 602 may perform a motion estimation operation for each PU of a CU. Motion compensation unit 604 may perform a motion compensation operation that generates a prediction block for the CU. TU generation unit 606 may perform a transform unit selection operation that generates transform units (TU's) of the CU. Smoothing unit 608 may perform a transition smoothing operation in which samples in transition zones of the prediction block are smoothed.

When motion estimation unit 602 performs the motion estimation operation for the CU, motion estimation unit 602 may generate one or more prediction trees. Each of the prediction trees may be associated with a different PU of the CU. Each of the prediction trees may specify a position and a size of a prediction area. For ease of explanation, this disclosure can refer to the position or size of the prediction area specified by the prediction tree of a PU as the position or size of the PU.

Motion estimation unit 602 may search one or more reference frames for reference samples. The reference samples of a PU may be areas of the reference frames that visually correspond to portions of the sample block of the CU that fall within the prediction area of the PU. If motion estimation unit 602 finds such a reference sample for one of the PU's, motion estimation unit 602 may generate a motion vector. The motion vector is a set of data that describes a difference between the spatial position of the reference sample for a PU and the spatial position of the PU. For example, the motion vector may indicate that the reference sample of a PU is five samples higher and three samples to the right of the PU. Furthermore, in some circumstances, motion estimation unit 602 may not be able to identify a reference sample for a PU. In such circumstances, motion estimation unit 602 may select a skip mode or a direct mode for the PU.

In some examples, rather than performing a search for a reference sample of a PU, motion estimation unit 602 may predict a motion vector for the PU. In performing this motion vector prediction, motion estimation unit 602 may select one of the motion vectors determined for spatially neighboring CU' s in the source frame or a motion vector determined for a co-located CU in a reference frame. Motion estimation unit 602 may perform motion vector prediction rather than search for a reference sample in order to reduce complexity associated with determining a motion vector for each partition.

Motion compensation unit 604 uses the inter-coding modes of the PU's to generate the prediction block of the CU. If motion estimation unit 602 selected the skip mode for a PU, motion compensation unit 604 may generate the prediction block of the CU such that samples in the prediction block that are associated with the PU match collocated samples in the reference frame. If motion estimation unit 602 selected the direct mode for a PU, motion compensation unit 604 may generate the prediction block such that samples in the prediction block that are associated with the PU match collocated samples in the sample block of the CU. If motion estimation unit 602 generated a motion vector for a PU, motion compensation unit 604 may generate the prediction block such that samples in the prediction block that are associated with the PU correspond to samples in a portion of the reference frame indicated by the motion vector.

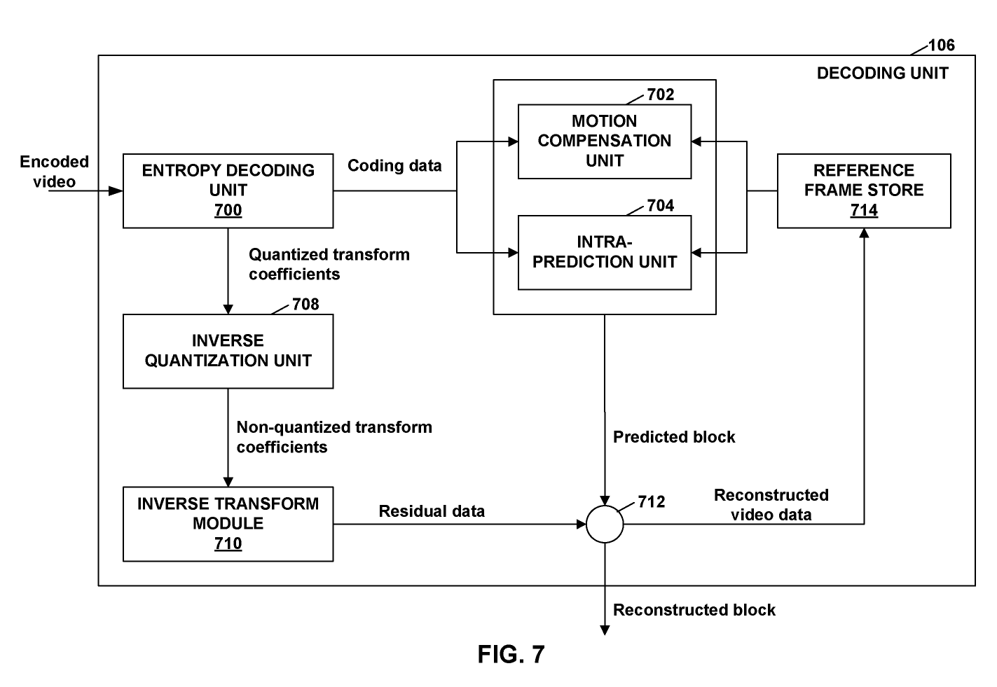

FIG. 7 is a block diagram that illustrates an example configuration of decoding unit 106. As illustrated in the example of FIG. 7, decoding unit 106 implements an entropy decoding unit 700, a motion compensation unit 702, an intra-prediction unit 704, an inverse quantization unit 708, an inverse transform module 710, a reconstruction unit 712, and a reference frame store 714. In various examples, decoding unit 106 implements these components in various ways. For example, the one or more computing devices that provide decoding unit 106 may implement these units when processors of the computing devices execute certain computer-readable instructions. In this example, these units or modules may or may not be implemented as discrete, modular pieces of computer software. In another example, the one or more computing devices that implement decoding unit 106 may comprise ASICs that provide the functionality of one or more of these units.

Decoding unit 106 receives an encoded bitstream that represents video data. The encoded bitstream may comprise data representing frames in the video data. For example, the encoded bitstream may comprise data representing each of frames 200 (FIG. 2). When decoding unit 106 receives data representing a frame, decoding unit 106 decodes the data to reconstruct the frame. For ease of explanation, this disclosure may refer to this frame as the source frame.

When decoding unit 106 decodes the data for the source frame, decoding unit 106 receives encoded data for each CU of the source frame. For example, decoding unit 106 can receive an encoded version of a quantized transform coefficient block for the CU, an encoded version of the coding node of the CU, an encoded version of the prediction tree of the CU, and an encoded version of the transform tree of the CU. Decoding unit 106 then decodes the data of each CU of the source frame. When decoding the data of a given CU, entropy decoding unit 700 receives encoded data for the given CU. Entropy decoding unit 700 performs an entropy decoding operation on the encoded data for the given CU. The entropy decoding operation reverses the effects of the entropy coding operation performed by entropy coding unit 316 (FIG. 3).

Entropy decoding unit 700 provides the quantized transform coefficient block for the CU to inverse quantization unit 708. Entropy decoding unit 700 may provide coding data for the CU, such as the coding node, prediction tree, and transform tree of the CU, to motion compensation unit 702 and/or intra-prediction unit 704.

When motion compensation unit 702 receives the coding data for the CU, motion compensation unit 702 uses the coding data to perform a motion compensation operation that generates a prediction block for the CU. During the motion compensation operation, motion compensation unit 702 may retrieve one or more reference frames from reference frame store 714. The motion compensation unit 702 may then identify reference samples for PU's of the CU. The motion vectors for the PU's identify areas within the reference frames as the reference samples for the PU's. After identifying the reference samples for PU's of the CU, motion compensation unit 702 generates a prediction block for the CU. In the prediction block, PU's of the CU may contain the reference samples of the PU's.

When intra-prediction unit 704 receives the coding data for the CU, intra-prediction unit 704 uses the reconstructed sample blocks of previously decoded CUs in the source frame to generate the prediction block for the CU. Intra-prediction unit 704 may modify the samples in the prediction block according to an indicated intra-prediction mode.

Inverse quantization unit 708 receives one or more quantized transform coefficient blocks for each CU. When inverse quantization unit 708 receives quantized transform coefficient block for a CU, inverse quantization unit 708 performs an inverse quantization operation that at least partially reverses the effect of the quantization operation performed by quantization unit 314 (FIG. 3), thereby generating non-quantized transform coefficient block for the CU.

Inverse transform module 710 performs an inverse transform operation on transform coefficient blocks. The inverse transform operation may reverse the effect of the transformation operation performed by transform module 312 (FIG. 3), thereby generating reconstructed residual data. In order to perform the transform operation on a transform coefficient block of a CU, inverse transform module 710 may need to determine a size of transform to apply to the transform coefficient block. If the CU has more than one PU, decoding unit 106 receives an indication (e.g., a syntax element) that indicates the size of the transform to apply to the transform coefficient block. Thus, decoding unit 106 may determine whether the syntax elements for the CU include an indication of the size of the transform (e.g., a size indicated syntax element). Hence, if the CU has more than one PU, decoding unit 106 may use the received indication to determine the size of the transform to apply to the transform coefficient block. Decoding unit 106 may then apply a transform of the indicated size to the transform coefficient block.

In accordance with the techniques of this disclosure, decoding unit 106 does not receive an indication of the size of the transform if the CU only has one PU. However, if decoding unit 106 determines that the syntax elements for the CU do not include an indication of the size of the transform, decoding unit 106 may assume that the size of the transform is equal to a size of the residual data of the CU. Thus, if decoding unit 106 does not receive an indication of the size of the transform, decoding unit 106 may apply a transform having the same size as the residual data of the CU to the transform coefficient block.

Reconstruction unit 712 receives the prediction blocks from motion compensation unit 702 and intra-prediction unit 704. Reconstruction unit 712 also receives corresponding reconstructed residual data from inverse transform module 710. Reconstruction unit 712 performs a reconstruction operation that uses a reconstructed residual data of a CU and a prediction block for the CU to generate a reconstructed sample block for the CU. In various examples, reconstruction unit 712 may perform various reconstruction operations. For example, reconstruction unit 712 may generate the reconstructed sample block of the CU by adding the samples in the reconstructed residual data of the CU with corresponding samples in the prediction block of the CU.

After generating a reconstructed sample block for a CU, reconstruction unit 712 outputs the reconstructed sample block. Reconstruction unit 712 also provides the reconstructed sample block to reference frame store 714. Reference frame store 714 stores the reconstructed sample block. Motion compensation unit 702 and/or intra-prediction unit 704 may subsequently use the reconstructed sample block to generate additional prediction blocks.

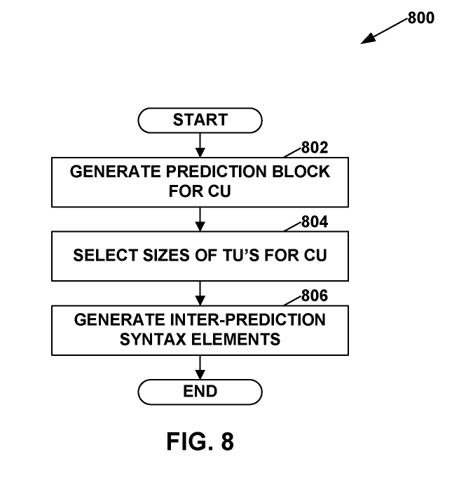

FIG. 8 is a flowchart that illustrates an example inter-frame coding operation 800 performed by inter-prediction unit 304. After encoding unit 104 starts inter-frame coding operation 800, inter-prediction unit 304 generates a prediction block for a CU (802). In some examples, inter-prediction unit 304 may generate multiple prediction blocks for the CU. Mode select unit 302 may then select one of the prediction blocks to be the prediction block for the CU. In various examples, inter-prediction unit 304 generates the prediction block in various ways.

In addition, TU generation unit 606 may perform a transform selection operation to select sizes of TU's for the CU (804). In other words, TU generation unit 606 may select the sizes of the transforms specified by the TU's. As discussed above, transform module 312 may receive residual data for the CU. Transform module 312 may then perform a transform operation on each TU of the CU. When transform module 312 performs the transform operation on a TU, transform module 312 may apply a transform specified by the TU to samples of the residual data in the transform area specified by the TU, thereby generating a transform coefficient block for the TU. Inverse transform unit 320 in encoding unit 104 and inverse transform module 710 in decoding unit 106 also use transforms having the selected transform sizes when transforming transform coefficient blocks into sample blocks.

Furthermore, inter-prediction unit 304 may generate inter-prediction syntax elements (806). The inter-prediction syntax elements may provide information about the CU and the prediction block. For example, the inter-prediction syntax elements may include syntax elements that indicate whether the CU has more than one PU. In this example, if the CU has more than one PU, the inter-prediction syntax elements may also indicate sizes, shapes, and/or locations of the prediction areas of the PU's. In another example, the inter-prediction syntax elements may specify inter-prediction modes for the PU's of the CU. Furthermore, the inter-prediction syntax elements may include data based on motion vectors for one or more of the PU's of the CU. In another example, the inter-prediction syntax elements may indicate sizes and/or location of TU's of the CU. In some examples, the set of inter-prediction syntax elements includes some or all of the inter-prediction syntax elements specified by the H.264 MPEG Part 10 standard or the emerging High Efficiency Video Coding (HEVC) standard.

If mode select unit 302 selects the prediction block generated in step 802, inter-prediction unit 304 may output the prediction block to residual generation unit 310 and reconstruction unit 322. Furthermore, if mode select unit 302 selects the prediction block generated in step 802, mode select unit 302 may include the intra-prediction syntax elements in the coding node, prediction tree, and/or transform tree of the CU.

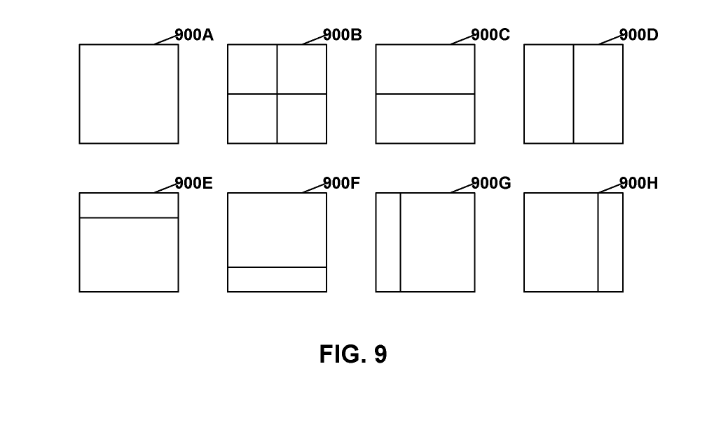

FIG. 9 is a conceptual diagram that illustrates example rectangular partitioning modes. As explained briefly above, motion estimation unit 602 may generate one or more PU's for a CU. Each of the PU's may have a prediction tree that specifies a size and a position of a prediction area. Each of the prediction areas may correspond to a different partition of the sample block of the CU. For ease of explanation, this disclosure may explain that a PU corresponds to a partition of the sample block of a CU when the prediction area specified by the prediction tree of the PU corresponds to the partition of the sample block of the CU.

In various examples, motion estimation unit 602 may use various partitioning modes to generate the PU's of the CU. Such partitioning modes may include rectangular partitioning modes. In rectangular partitioning modes, the PU's correspond to rectangular-shaped partitions of the sample block of the CU. In some examples, motion estimation unit 602 is able to use some or all rectangular partitioning modes defined in the H.264 MPEG Part 10 standard.

The example of FIG. 9 illustrates rectangular partitioning modes 900A-H (collectively, “rectangular partitioning modes 900”). In rectangular partitioning mode 900A, motion estimation unit 602 generates a single PU for the CU. The prediction area of this PU is the same size as the sample block of the CU. In rectangular partitioning mode 900B, motion estimation unit 602 generates four PU's for the CU. The PU's generated using rectangular partitioning mode 900B correspond to four equally-sized partitions of the sample block of the CU.

In rectangular partitioning modes 900C through 900H, motion estimation unit 602 generates two PU's for the CU. The PU's generated using rectangular partitioning mode 900C correspond to equally-sized, horizontally-divided partitions of the sample block of the CU. The PU's generated using rectangular partitioning mode 900D correspond to equally-sized, vertically-divided partitions of the sample block of the CU.

The PU's generated using rectangular partitioning mode 900E correspond to horizontally-divided partitions of the sample block in which the lower partition is larger than the upper partition. In some examples, motion estimation unit 602 may partition the sample block horizontally at any sample in the sample block above a horizontal midline of the sample block. The PU's generated using rectangular partitioning mode 900F correspond to horizontally-divided partitions of the sample block in which the lower partition is smaller than the upper partition. In some examples, motion estimation unit 602 may partition the sample block horizontally at any sample in the sample block below a horizontal midline of the sample block.

The PU's generated using rectangular partitioning mode 900G correspond to vertically-divided partitions of the sample block in which the left partition is smaller than the right partition. In some examples, motion estimation unit 602 may partition the sample block vertically at any sample in the sample block to the left of a vertical midline of the sample block. The PU's generated using rectangular partitioning mode 900H correspond to vertically-divided partitions of the sample block in which the left partition is larger than the right partition. In some examples, motion estimation unit 602 may partition the sample block vertically at any sample in the sample block to the right of a vertical midline of the sample block.

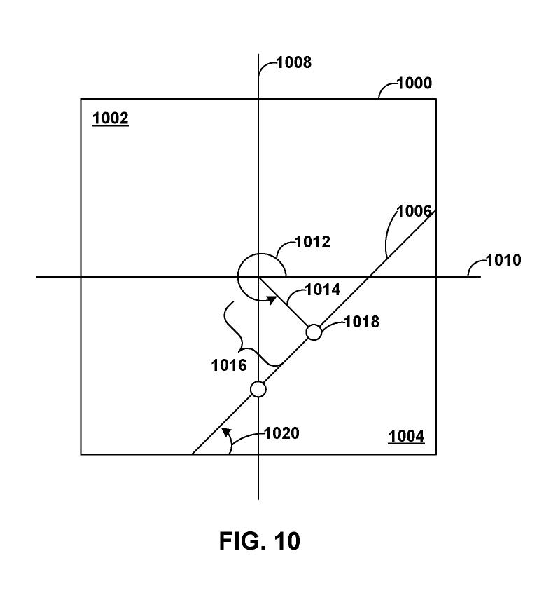

FIG. 10 is a conceptual diagram that illustrates example geometric partitioning modes. In some examples, motion estimation unit 602 uses a geometric partitioning mode to generate two PU's for a CU. When motion estimation unit 602 uses a geometric partitioning mode to generate the PU's for the CU, the PU's correspond to partitions of the sample block of the CU whose boundaries do not necessarily meet the edges of the sample block at right angles.

In the example of FIG. 10, motion estimation unit 602 has used a geometric partitioning mode to partition a sample block 1000 into a first partition 1002 and a second partition 1004. A partitioning line 1006 separates first partition 1002 and second partition 1004. For ease of explanation, FIG. 10 illustrates a vertical midline 1008 and a horizontal midline 1010 of sample block 1000. Two parameters define the geometric partitioning mode used to partition sample block 1000. In this disclosure, these two parameters are referred to as theta and rho. The theta parameter indicates an angle 1012 at which a line 1014 extends from a central point of sample block 1000. The rho parameter indicates a length 1016 of line 1014. Thus, the theta and rho parameters act as polar coordinates to indicate a point 1018 within sample block 1000. Partitioning line 1006 is defined such that partitioning line 1006 meets line 1014 at a right angle. In the example of FIG. 10, an angle 1020 at which partitioning line 1006 meets an edge of sample block 1000 is not a right angle. In this way, the theta and rho parameters define the location of partitioning line 1006. By using various values for the theta and rho parameters, motion estimation unit 602 may define various lines that partition sample block 1000.

Partitioning line 1006 and line 1014 are not necessarily visually present in sample block 1000 and are shown in FIG. 10 to illustrate how sample block 1000 may be geometrically partitioned.

FIG. 10 is a conceptual diagram that illustrates an example quadtree 1100. Quadtree 1100 may be a data structure that stores data, such as syntax elements, regarding a given treeblock and partitions of the given treeblock. As described above with regard to the example FIG. 4, encoding unit 104 may divide a frame, e.g., frame 200A, into a set of treeblocks 400. As described above with regard to the example of FIG. 5, encoding unit 104 may further partition treeblocks 400 into smaller sample blocks, e.g., sub-blocks 500, 502. Encoding unit 104 may further partition the smaller sample blocks into yet smaller sample blocks, e.g., sub-sub-blocks 504. Encoding unit 104 may continue subdividing treeblocks 400 in this manner so long as encoding unit 104 does not reach a minimum partition size and subdividing partitions increases coding efficiency.

Encoding unit 104 may generate syntax elements with regard to each of treeblocks 400 and partitions of treeblocks 400. Encoding unit 104 may store the syntax elements regarding treeblocks 400 in quadtree data structures, such as quadtree 1100.

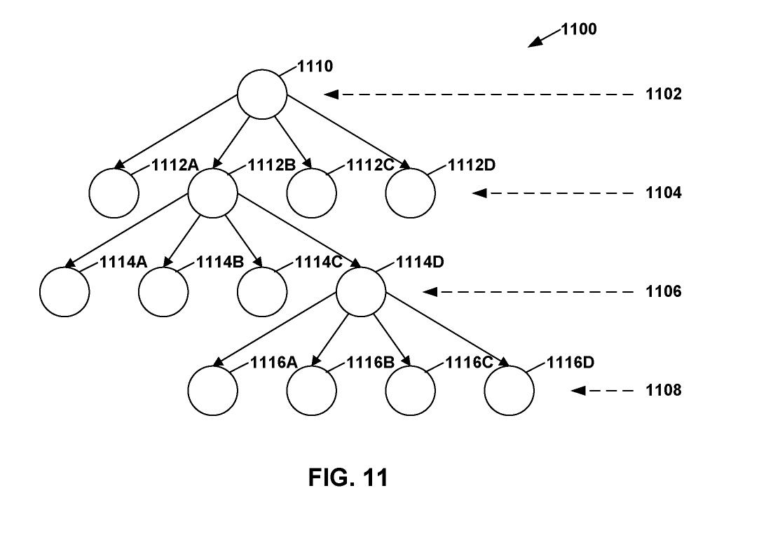

In the example of FIG. 11, encoding unit 104 has partitioned a given treeblock into four sub-blocks. Encoding unit 104 has partitioned one of the sub-blocks into four sub-sub-blocks. Encoding unit 104 has also partitioned one of the sub-sub-blocks into four sub-sub-sub-blocks. In other examples, encoding unit 104 may partition the given treeblock in different ways. For example, encoding unit 104 may partition the given treeblock such that multiple sub-blocks are divided into sub-sub-blocks.

Quadtree 1100 has four levels, a root level 1102, a child level 1104, a grandchild level 1106, and a great-grandchild level 1108. Root level 1102 includes a root node 1110. Root node 1110 stores syntax elements regarding the given treeblock. Child level 1104 includes nodes 1112A-2212D (collectively, “nodes 1112”). Nodes 1112 store syntax elements regarding the sub-partitions. Grandchild level 1106 includes nodes 1114A-1114D (collectively, “nodes 1114”). Nodes 1114 store syntax elements regarding the sub-sub-partitions. Great-grandchild level 1108 includes nodes 1116A-2216D (collectively, “nodes 1116”). Nodes 1116 store syntax elements regarding the sub-sub-sub-partitions.

Nodes 1112A, 1112D, 1114A, 1114B, 1114C, 1116A, 1116B, 1116C, and 1116D are leaf nodes of quadtree 1100. In other words, nodes 1112A, 1112D, 1114A, 1114B, 1114C, 1116A, 1116B, 1116C, and 1116D are coding nodes of quadtree 1100.

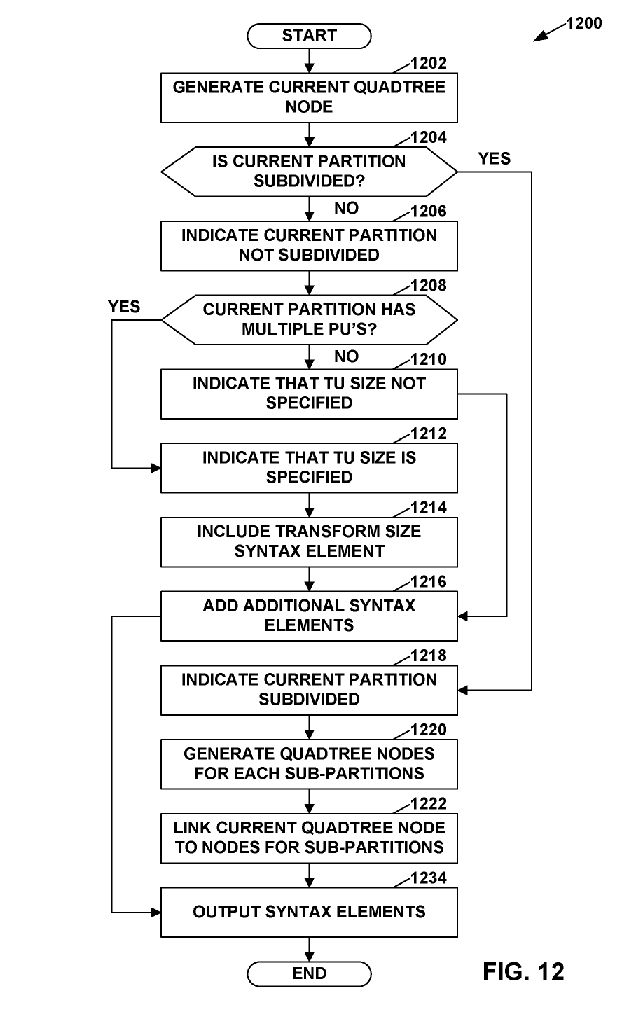

FIG. 12 is a flowchart illustrating an example operation 1200 to generate a node of quadtree 1100. Operation 1200 is a recursive operation. Performance of operation 1200 may cause encoding unit 104 to perform operation 1200 with regard to each sub-block of a given treeblock. Performance of operation 1200 with regard to a sub-block of the given treeblock may cause encoding unit 104 to perform operation 1200 with regard to each sub-sub-block of the sub-block, and so on.

Coding efficiency may be improved if fewer bits are used to represent CU's. Specifying the sizes of TU's of the CU's may increase the number of bytes required to represent the CU's. By performing operation 1200, it may be unnecessary to specify the sizes of some of the TU's. This may increase coding efficiency.

After encoding unit 104 starts operation 1200, mode select unit 302 may generate a node structure for a current block (1202). The current block may be a treeblock as a whole, a partition of the treeblock, a sub-partition of the treeblock, and so on. For ease of explanation, this disclosure refers to the node structure for the current block as the current quadtree node. In various examples, the current quadtree node may be represented in various ways. For example, the current quadtree node may be represented as a series of bits. In this example, the series of bits are divided according to a predetermined scheme such that syntax elements may be extracted from the series of bits.

After generating the current quadtree node, encoding unit 104 may determine whether the current block is partitioned into sub-blocks (1204). If encoding unit 104 determines that the current block is not subdivided into sub-blocks (“NO” of 1204), mode select unit 302 may include a syntax element in the current quadtree node to indicate that the current block is not subdivided into sub-blocks (1206). For example, if the current block corresponds to a coding unit, mode select unit 302 may set a syntax element in the current quadtree node to indicate that the current block is not subdivided into further sub-blocks.

In accordance with the techniques of this disclosure, if the current block is not subdivided into sub-blocks, encoding unit 104 determines whether the current block has multiple PU's (1208). In the example of FIG. 12, if the current block does not have multiple PU's, the current block only has a single TU. Because the current block only has a single TU, transform module 312 transforms the residual data for the current block using exactly one, i.e., a single, transform that has a same size as the current block. While described as transforming the residual data for the current block using exactly one, i.e., a single, transform, transforms may be applied in a number of different ways. For example, to transform a two-dimensional block of pixel values (which is referred to as a sample block in this disclosure), a one-dimensional transform may be applied in the horizontal and then vertical direction to implement a two-dimensional transform. When referring to using exactly one transform, the techniques may refer to exactly one two-dimensional transform or any other order transform to transform two-dimensional video data or any other order video data. Hence, if encoding unit 104 determines that the current block has only one PU, transform module 312 transforms the residual data of the current block using exactly one transform having a transform size equal to a size of the sample block of the current block.

If the current block does not have multiple PU's (“NO” of 1208), mode select unit 302 includes a size indicated syntax element to indicate that the syntax elements for the current block (i.e., CU) do not explicitly include a transform size syntax element (1210). For example, mode select unit 302 may set a value of a size indicated syntax element to 0 to indicate that the syntax elements for the current block do not include the size of the TU. In some examples, mode select unit 302 includes the size indicated syntax element in a transform tree of the current quadtree node.

On the other hand, if the current block has multiple PU's (“YES” of 1208), mode select unit 302 sets the size indicated syntax element to indicate that the syntax elements for the current block include a transform size syntax element (1212). For example, mode select unit 302 may set a value of the size indicated syntax element to 1 to indicate that the syntax elements for the current block include the transform size syntax element. In some examples, mode select unit 302 includes the size indicated syntax element in the transform tree of the current quadtree node.

In some examples, TU generation unit 606 selects the sizes of TU's, and hence sizes of transforms, for the current block such that the transforms do not cross boundaries between PU's of the current block. As described above, the PU's can be generated using rectangular or geometric partitioning modes. When a TU crosses a boundary between PU's of a partition, levels of distortion may increase. Thus, when the current block (i.e., the CU) has multiple PU's, TU generation unit 606 may select the sizes of transforms such that the transforms do not cross boundaries between PU's.

In addition, if the current block has multiple PU's, mode select unit 302 may include a transform size syntax element in the syntax elements of the current block (1214). The transform size syntax element indicates a size of a TU. In other words, the transform size syntax element indicates a size of a transform area of the TU. For example, mode select unit 302 may include a transform size syntax element that indicates that the size of a TU is 4 samples by 4 samples (i.e., 4×4). In some examples, mode select unit 302 includes the transform size syntax element in the transform tree of the current quadtree node.

After performing either step 1210 or step 1214, mode select unit 302 may generate one or more additional syntax elements for current block (1216). For example, mode select unit 302 may add a syntax element to the current quadtree node that indicates a size of the current block. In some examples, mode select unit 302 may add the one or more additional syntax elements to the current quadtree node, the transform tree of the current quadtree node, or the prediction tree of the current quadtree node.

If the current block is partitioned into multiple sub-blocks (“YES” of 1204), mode select unit 302 may indicate in the syntax elements for the current block that the current block is partitioned (1218). For example, mode select unit 302 may include a partition flag in the current quadtree node having a value of 1 to indicate that the current block is partitioned. In addition, mode select unit 302 may generate quadtree nodes for each sub-block of the current block (1220). In some examples, mode select unit 302 generates the quadtree node for a sub-block by performing operation 1200 with the sub-block as the current block.

After mode select unit 302 generates the quadtree nodes for the sub-blocks, mode select unit 302 may link the current quadtree node to the quadtree nodes for the sub-blocks (1222). In various examples, mode select unit 302 may link the current quadtree node to the quadtree nodes for the sub-blocks in various ways. For example, mode select unit 302 may include the quadtree nodes for the sub-blocks within the current quadtree node. In another example, mode select unit 302 may include data in the current quadtree node indicating storage locations of the quadtree nodes for the sub-blocks. In another example, quadtree nodes for the sub-blocks follow the current quadtree node in a bitstream.

After linking the current quadtree node to the quadtree nodes for the sub-blocks in step 1222 or after adding the additional syntax elements to the current quadtree node in 1216, mode select unit 302 may output syntax elements for the current block (1234). If the current block is a sub-block of another partition, mode select unit 302 may output the syntax elements to an instance of operation 1200 that is generating the quadtree node for the other block. If the current block is not a sub-blocks of another partition, mode select unit 302 may output the syntax elements to entropy coding unit 316. In this way, mode select unit 302 may output syntax elements that include a transform size syntax element for the current block only when the current block has more than one PU. In some examples, mode select unit 302 may output the syntax elements for the current block by outputting the current quadtree node, transform tree, and prediction tree. Thus, mode select unit 302 may provide a transform size syntax element in a node of quadtree data structure, the node corresponding to the CU. In this way, encoding unit 104 may output an indication of the transform size only when the CU has more than one prediction unit. Furthermore, in this way, encoding unit 104 may output a size indicated syntax element for the CU, the size indicated syntax element indicates that syntax elements for the CU do not indicate the transform size when the CU only has one PU.

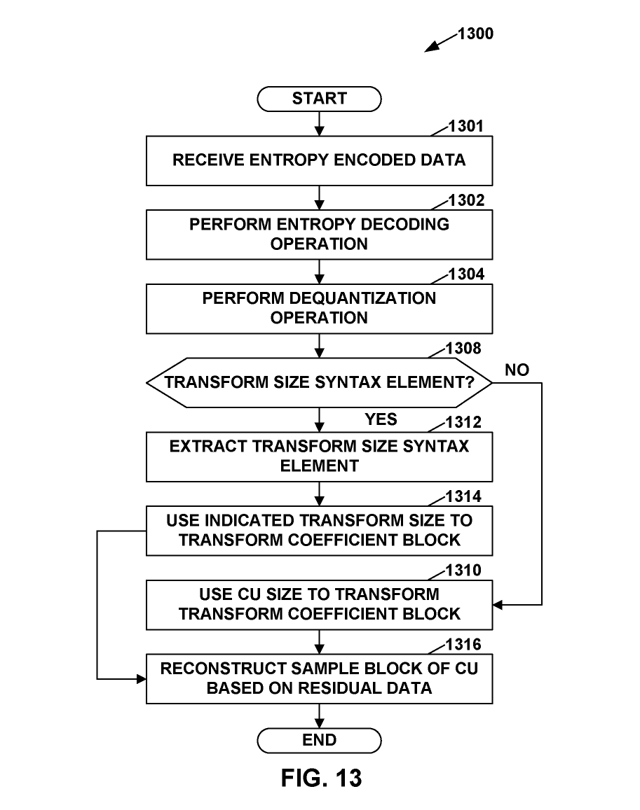

FIG. 13 is a flowchart illustrating an example operation 1300 performed by decoding unit 106. When decoding unit 106 decodes video data, decoding unit 106 may receive entropy encoded data of a CU (1301). The entropy encoded data of the CU may include data representing a quantized transform coefficient block of the CU and syntax elements for the CU. In some examples, decoding unit 106 receives a quadtree data structure. In such examples, the quadtree data structure may include a coding node for the CU, along with a prediction tree and a transform tree for the CU. The coding node, prediction tree, and the transform tree for the CU specify syntax elements of the CU. Thus, if the syntax elements for the CU include a transform size syntax element, decoding unit 106 may receive the transform size syntax element in a node of a quadtree data structure, the node corresponding to the CU. This node may also include a size indicated syntax element that indicates whether the node for the CU includes the transform size syntax element.

After decoding unit 106 receives the entropy encoded data, entropy decoding unit 700 performs an entropy decoding operation to decode a quantized transform coefficient block and the syntax elements of the CU (1302). The syntax elements of the CU may include a size indicated syntax element. The size indicated syntax element may indicate whether the syntax elements of the CU include a transform size syntax element.

Inverse quantization unit 708 may perform a dequantization operation on the quantized transform coefficient block to generate a transform coefficient block (1304). After generating the transform coefficient block, decoding unit 106 determines whether the size indicated syntax element indicates that the syntax elements of the CU include a transform size syntax element (1308). For example, decoding unit 106 may determine whether the size indicated syntax element indicates that the transform tree of the CU includes the transform size syntax element. If the size indicated syntax element indicates that the syntax elements do not include the transform size syntax element (“NO” of 1308), inverse transform module 710 of decoding unit 106 may infer that a transform area of the TU of the CU is the same size as the residual data of the CU. Hence, inverse transform module 710 may use a transform having the same size as the residual data of the CU to transform the transform coefficient block of the CU into the residual data (1310). Thus, inverse transform module 710 may transform the transform coefficient block for the CU into residual data using a first transform when the syntax elements do not specify the transform size syntax element, the first transform having a same size as the residual data of the CU.

On the other hand, if the size indicated syntax element indicates that the syntax elements includes the transform size syntax element (“YES” of 1308), decoding unit 106 extracts the transform size syntax element from the syntax elements (1312). The transform size syntax element indicates a transform size. In various examples, decoding unit 106 may extract the transform size syntax element in various ways. For example, the transform size syntax element may always occur at a location that is a given number of bits before or after the size indicated syntax element. In this example, decoding unit 106 may be configured to extract the transform size syntax element from the location at the given number of bits before or after the size indicated syntax element.

After extracting the transform size syntax element, inverse transform module 710 uses one or more transforms having the indicated transform size to transform the transform coefficient block into residual data (1314). Thus, inverse transform module 710 transforms the transform coefficient block for the CU into the residual data using at least a second transform when the syntax elements specify the transform size syntax element, the second transform having the transform size indicated by the transform size syntax element. After inverse quantization unit 710 generates the residual data in steps 1310 or 1314, decoding unit 106 may continue a process of reconstructing the sample block of the CU based on the residual data (1316).

In some examples, encoding unit 104 performs an operation similar to operation 1300 to reconstruct reference frames. In such examples, inverse quantization unit 318 may dequantize the transform coefficient block of the CU and inverse transform unit 320 may apply transforms in the manner described above to regenerate residual data for the CU. Thus, operation 1300 may be performed when encoding and decoding video data.

In one or more examples, the functions described may be implemented in hardware, software, firmware, or any combination thereof. If implemented in software, the functions may be stored on or transmitted as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the invention defined by the following claims.

What is claimed is:

1. A method of encoding video data, the method comprising:
generating residual data for a coding unit (CU) of the video data;
transforming the residual data using at least one transform, the transform having a particular transform size;
determining whether the CU has more than one prediction unit; and
outputting an indication of the transform size only after determining that the CU has more than one prediction unit.

2. The method of claim 1, further comprising:
wherein transforming the residual data comprises after determining that the CU does not have more than one prediction unit, transforming the residual data using exactly one transform having a transform size equal to a size of the residual data of the CU.

3. The method of claim 1, wherein transforming the residual data comprises:
when the CU has multiple prediction units, selecting sizes of transforms such that the transforms do not cross boundaries between the prediction units; and
transforming the residual data using the transforms.

4. The method of claim 1, further comprising outputting a size indicated syntax element for the CU, the size indicated syntax element indicating that syntax elements for the CU do not indicate the transform size when the CU only has one prediction unit.

5. The method of claim 4, wherein the size indicated syntax element indicates that the syntax elements indicate the transform size when the CU has more than one prediction unit.

6. The method of claim 1, wherein outputting the indication comprising providing the indication in a node of a quadtree data structure, the node corresponding to the CU.

7. A method for decoding video data, the method comprising:
receiving syntax elements, the syntax elements including a transform size syntax element for a coding unit (CU) of video data only when the CU has more than one prediction unit, the transform size syntax element indicating the transform size;
determining whether the syntax elements include the transform size syntax element;
transforming a transform coefficient block for the CU into residual data for the CU using a first transform after determining that the syntax elements do not include the transform size syntax element, the first transform having a same size as the residual data for the CU; and
reconstructing the sample block of the CU based on the residual data for the CU.

8. The method of claim 7, further comprising: transforming the transform coefficient block for the CU into the residual data using at least a second transform after determining that the syntax elements include the transform size syntax element, the second transform having the transform size indicated by the transform size syntax element.

9. The method of claim 7, further comprising:
determining whether the syntax elements include a size indicated syntax element; and
extracting the transform size syntax element from among the syntax elements after determining that the syntax elements include the size indicated syntax element.

10. The method of claim 7, wherein receiving the syntax elements comprises receiving the transform size syntax element in a node of a quadtree data structure, the node corresponding to the CU.

11. The method of claim 10, wherein the node for the CU includes a size indicated syntax element that indicates whether the node for the CU includes the transform size syntax element.

12. A computing device that comprises a processor configured to:
generate residual data for a coding unit (CU) of video data;
transform the residual data using at least one transform, the transform having a particular transform size;
determine whether the CU has more than one prediction unit; and
output an indication of the transform size only after determining that the CU has more than one prediction unit.

13. The computing device of claim 12, wherein the processor is configured to transform the residual data using exactly one transform after determining that the CU comprises does not have more than one prediction unit, the transform having a transform size equal to a size of the residual data of the CU.

14. The computing device of claim 12, wherein the processor is configured to:
select sizes of transforms when the CU has multiple prediction units, the sizes of the transforms selected such that the transforms do not cross boundaries between the prediction units; and
transform the residual data using the transforms.

15. The computing device of claim 12, wherein the processor is configured to output a size indicated syntax element for the CU, the size indicated syntax element indicating that syntax elements for the CU do not indicate the transform size when the CU only has one prediction unit.

16. The computing device of claim 15, wherein the size indicated syntax element indicates that the syntax elements indicate the transform size after determining that the CU has more than one prediction unit.

17. The computing device of claim 12, wherein the processor is configured to provide the indication in a node of a quadtree data structure, the node corresponding to the CU.

18. A computing device that comprises a processor configured to:
receive syntax elements, the syntax elements including a transform size syntax element for a coding unit (CU) of video data only when the CU has more than one prediction unit, the transform size syntax element indicating a transform size;
determine whether the syntax elements include the transform size syntax element;
transform a transform coefficient block for the CU into residual data for the CU using a first transform after determining that the syntax elements do not include the transform size syntax element, the first transform having a same size as the residual data for the CU; and
reconstruct the sample block of the CU based on the residual data for the CU.

19. The computing device of claim 18, wherein the processor is configured to transform the transform coefficient block for the CU into the residual data using at least a second transform after determining that the syntax elements include the transform size syntax element, the second transform having the transform size indicated by the transform size syntax element.

20. The computing device of claim 18, wherein the processor is configured to:
determine whether the syntax elements include a size indicated syntax element; and
extract the transform size syntax element from among the syntax elements after determining that the syntax elements include the size indicated syntax element.

21. The computing device of claim 18, wherein the processor is configured to receive the transform size syntax element in a node of a quadtree data structure, the node corresponding to the CU.

22. The computing device of claim 21, wherein the node for the CU includes a size indicated syntax element that indicates whether the node for the CU includes the transform size syntax element.

23. A computing device comprising:
means for generating residual data for a coding unit (CU) of video data;
means for transforming the residual data using at least one transform, the transform having a particular transform size;
means for determining whether the CU has more than one prediction unit; and
means for outputting an indication of the transform size only after determining that the CU has more than one prediction unit.

24. The computing device of claim 23, comprising means for transforming the residual data using exactly one transform after determining that the CU does not have more than one prediction unit, the transform having a transform size equal to a size of the residual data of the CU.

25. The computing device of claim 23, further comprising means for outputting a size indicated syntax element for the CU, the size indicated syntax element indicating that syntax elements for the CU do not indicate the transform size after determining that the CU does not have more than one prediction unit.

26. A computing device comprising:
means for receiving syntax elements, the syntax elements including a transform size syntax element for a coding unit (CU) of video data only when the CU has more than one prediction unit, the transform size syntax element indicating a transform size;
means for determining whether the syntax elements include the transform size syntax element;
means for transforming a transform coefficient block for the CU into residual data for the CU using a first transform after determining that the syntax elements do not include the transform size syntax element, the first transform having a same size as the CU; and
means for reconstructing the sample block of the CU based on the residual data for the CU.

27. The computing device of claim 26, comprising means for transforming the transform coefficient block for the CU into the residual data using at least a second transform after determining that the syntax elements include the transform size syntax element, the second transform having the transform size indicated by the transform size syntax element.

28. The computing device of claim 26, comprising:
means for determining whether the syntax elements include a size indicated syntax element; and
means for extracting the transform size syntax element from among the syntax elements after determining that the syntax elements include the size indicated syntax element.

29. A computer program product that comprises a computer-readable storage medium that stores program instructions that cause a computing device to:
generate residual data for a coding unit (CU) of video data;
transform the residual data using at least one transform, the transform having a particular transform size;
determine whether the CU has more than one prediction unit; and
output an indication of the transform size only after determining that the CU has more than one prediction unit.

30. A computer program product that comprises a computer-readable storage medium that stores program instructions that cause a computing device to:
determine whether syntax elements for a coding unit (CU) of video data include a transform size syntax element, the syntax elements including the transform size syntax element only when the CU has more than one prediction unit, the transform size syntax element indicating a transform size;
transform a transform coefficient block for the CU into residual data using a transform after determining that the syntax elements do not include the transform size syntax element, the transform having a same size as the residual data of the CU; and
reconstruct a sample block of the CU based on the residual data for the CU.
